(19) United States
(12) Patent Application Publication
(10) Pub. No.: US 2008/0234165 A1
(43) Pub. Date: Sep. 25, 2008

(54) Liquid laundry detergent compositions comprising performance boosters

(76) Inventors: Rajan Keshav Panandiker, West Chester, OH (US); Kerry Andrew Vetter, Cincinnati, OH (US); Mary Jane Combs, Covington, KY (US); David Gladney, Cincinnati, OH (US); Connie Lynn Sheets, Cincinnati, OH (US); Gayle Marie Frankenbach, Cincinnati, OH (US); Rafael Trujillo Rosaldo, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/075,333

(22) Filed: Mar. 11, 2008

Related U.S. Application Data
(60) Provisional application No. 60/919,106, filed on Mar. 20, 2007.

(51) Int. Cl. C11D 3/00; C11D 1/02; C11D 3/386

(52) U.S. Cl. 510/299; 510/337; 510/343; 510/321; 510/325

(57) ABSTRACT

Liquid laundry detergent compositions comprising anionic surfactant, fabric care agent, cationic deposition aid and performance booster are disclosed. The performance booster is chosen such that it will not react with the cationic deposition aid or fabric care agent to form a coacervate and/or to precipitate from solution. Such performance boosters may compensate for reduced cleaning efficacy of anionic surfactants and/or fabric care agents which interact with cationic deposition aids.

### CROSS REFERENCE TO RELATED APPLICATION

This application claims the benefit of U.S. Provisional Application No. 60/919,106, filed Mar. 20, 2007.

### FIELD OF THE INVENTION

The present invention relates to liquid laundry detergent compositions comprising anionic surfactant, fabric care agent, cationic deposition aid and performance booster. The performance booster is chosen such that it will not react with the cationic deposition aid or fabric care agent to form a coacervate and/or to precipitate from solution. Such performance boosters may compensate for reduced cleaning efficacy of anionic surfactants and/or fabric care agents which interact with cationic deposition aids.

### BACKGROUND OF THE INVENTION

Fabric may be laundered to remove stains, odors, soils and the like. Unfortunately, the laundering process may also impart fabric with mechanical and/or chemical damage, which may in turn result in undesirable side effects including, but not limited to, wrinkling, color fading, dye transfer, pilling/fuzzing, fabric wear, fiber deterioration, stiffening, and the like. Consequently, many laundry products such as detergents, fabric conditioners, and other wash, rinse, and dryer-added products, typically include one or more fabric care agents. The fabric care agents are added to laundry products in an attempt to reduce or prevent the undesirable side effects, and/or to improve the characteristics of fabrics, such as look and feel, for example.

Fabric care agents often provide limited benefits due to poor delivery efficiency onto fabrics during the laundering/washing process. Without wishing to be bound by theory, it is believed that the poor delivery efficiency is a consequence of limited affinity between fabric care agents and fabrics due to a lack of natural attractive forces. Typically, fabric care agents are anionic or nonionic in order to avoid interaction with anionic surfactants that may be present in a laundry product to provide for efficient cleaning. Since many fabric fibers such as cotton, wool, silk, nylon and the like carry a slightly anionic charge in wash liquor, repulsive instead of attractive forces may exist between the fabric care agent and the fabric fibers, thereby resulting in poor delivery efficiency of the agent to the fabric.

In order to increase the deposition of actives in the wash process, cationic deposition aids may be used in laundry products. Cationic deposition aids are high molecular weight polymers which can form a coacervate with anionic surfactants in the wash liquor. Without wishing to be bound by theory, it is believed that coacervates deposit onto fabrics during the wash process, carrying fabric care agents with them. However, it is also believed that this interaction decreases the cleaning efficiency of the anionic surfactants. It is further believed that cationic deposition aids may interact with fabric care agents comprising a negative charge such that they precipitate out of solution thereby reducing their efficacy as well.

It may therefore be desirable to incorporate into liquid laundry detergent compositions performance boosters which do not interact with cationic deposition aids or fabric care agents comprising a negative charge to coacervate and/or to precipitate from solution. Such performance boosters could compensate for any reduced cleaning efficacy of anionic surfactants and/or fabric care agents that interact with cationic deposition aids. It may also be desirable to incorporate ingredients which give pleasing aesthetic benefits to the liquid laundry detergent compositions including, but not limited to, improved appearance, aroma and rheology.

### SUMMARY OF THE INVENTION

The present invention relates to liquid laundry detergent compositions comprising by weight percentage of said composition: from about 1% to about 80% of anionic surfactant; from about 0.1% to about 10% of fabric care agent; from about 0.01% to about 2% of deposition aid; and from about 0.05% to about 10% of performance booster selected from enzymes, anionic polymers, and brighteners.

In some embodiments of the present invention, the anionic surfactants of use in the present compositions are selected from the group of: C₈-C₂₂ fatty acid or its salts; C₁₁-C₁₈ alkyl benzene sulfonates; C₁₀-C₂₀ branched-chain and random alkyl sulfates; C₁₀-C₁₈ alkyl alkoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units; modified alkylbenzene sulfonate; C₁₂-C₂₀ methyl ester sulfonate; C₁₀-C₁₈ alpha-olefin sulfonate; C₆-C₂₀ sulfosuccinates; and combinations thereof.

In some embodiments of the present invention, the liquid laundry detergent compositions further comprise pearlescent agent. Pearlescent agents of use include, but are not limited to those selected from the group of: mica; bismuth oxychloride; fish scales; mono and diesters of alkylene glycol of the formula:

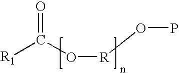

wherein:
a. R₁ is linear or branched C12-C22 alkyl group;
b. R is linear or branched C2-C4 alkylene group;
c. P is selected from the group of: H; C1-C4 alkyl; or —COR₂; and
d. n=1-3.

The present invention also relates to methods of laundering fabric. The methods include the step of contacting the fabric to be laundered with a liquid laundry detergent composition of the present invention.

### DETAILED DESCRIPTION OF THE INVENTION

“Fabric”, “textile” and “garment” are used interchangeably herein to refer to an artifact that is made using any suitable means including, but not limited to weaving, felting, knitting, crocheting and combinations thereof, of natural fibers, synthetic fibers and combinations thereof. Nonwovens are also meant to be encompassed by these terms.

“Performance booster” as used herein refers to any material useful in a liquid laundry detergent composition to increase cleaning, which does not “negatively interact” with cationic deposition aid and/or fabric care agent. “negatively interact” as used herein refers to forming a coacervate and/or precipitating from solution, in the liquid laundry detergent composition itself, and/or when the liquid laundry detergent composition is present in a wash liquor. Such “negative interaction” can decrease the cleaning efficiency of a liquid laundry detergent composition.

“Cleaning” is used herein in the broadest sense to mean removal of unwanted substances from fabric. “Cleaning” includes, but is not limited to, the removal of soil from fabric and prevention of re-deposition of soil onto fabric.

“Liquid detergent composition” as used herein, refers to compositions that are in a form selected from the group of: “pourable liquid”; “gel”; “cream”; and combinations thereof.

“Pourable liquid” as defined herein refers to a liquid having a viscosity of less than about 2000 mPa*s at 25° C. and a shear rate of 20 sec-¹. In some embodiments, the viscosity of the pourable liquid may be in the range of from about 200 to about 1000 mPa*s at 25° C. at a shear rate of 20 sec-¹. In some embodiments, the viscosity of the pourable liquid may be in the range of from about 200 to about 500 mPa*s at 25° C. at a shear rate of 20 sec-¹.

“Gel” as defined herein refers to a transparent or translucent liquid having a viscosity of greater than about 2000 mPa*s at 25° C. and at a shear rate of 20 sec-¹. In some embodiments, the viscosity of the gel may be in the range of from about 3000 to about 10,000 mPa*s at 25° C. at a shear rate of 20 sec-¹ and greater than about 5000 mPa*s at 25° C. at a shear rate of 0.1 sec-¹.

“Cream” and “paste” are used interchangeably and as defined herein refer to opaque liquid compositions having a viscosity of greater than about 2000 mPa*s at 25° C. and a shear rate of 20 sec-¹. In some embodiments, the viscosity of the cream may be in the range of from about 3000 to about 10,000 mPa*s at 25° C. at a shear rate of 20 sec-¹, or greater than about 5000 mPa*s at 25° C. at a shear rate of 0.1 sec-¹.

“Comprising” as used herein means that various components, ingredients or steps can be conjointly employed in practicing the present invention. Accordingly, the term “comprising” encompasses the more restrictive terms “consisting essentially of” and “consisting of”. The present compositions can comprise, consist essentially of, or consist of any of the required and optional elements disclosed herein.

The articles “a”, “an” and “the” as used herein refer to “one or more”, unless otherwise indicated.

Markush language as used herein encompasses combinations of the individual Markush group members, unless otherwise indicated.

All percentages, ratios and proportions used herein are by weight percent of the composition, unless otherwise specified. All average values are calculated “by weight” of the composition or components thereof, unless otherwise expressly indicated.

All numerical ranges disclosed herein, are meant to encompass each individual number within the range and to encompass any combination of the disclosed upper and lower limits of the ranges.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

The present liquid laundry detergent compositions address the aforementioned problems through the selection of specific performance boosters comprising negative charge and cationic deposition aids such that they will not “negatively interact” to decrease the cleaning efficiency of the compositions. The present liquid laundry detergent compositions comprise: (I) anionic surfactant; (II) fabric care agent; (III) cationic deposition aid; and (IV) performance booster. In some embodiments, the liquid laundry detergent compositions further comprise (V) laundry adjunct. Each of these components as well methods of preparing and using such compositions are described in detail as follows.

### I. Anionic Surfactant

The liquid laundry detergent products of the present invention may comprise from about 1% to about 80%, or from about 5% to about 50% by weight of anionic surfactant. Anionic surfactants of use in the present invention are described in “Surfactants in Consumer Products” edited by J. Falbe published by Springer Verlag, Berlin (1986).

Useful anionic surfactants can themselves be of several different types. For example, water-soluble salts of the higher fatty acids, i.e., “soaps”, are useful anionic surfactants in the present compositions. Non-limiting examples include alkali metal soaps such as the sodium, potassium, ammonium, and alkylolammonium salts of higher fatty acids containing from about 8 to about 24 carbon atoms, or from about 12 to about 18 carbon atoms. Soaps can be made by direct saponification of fats and oils or by the neutralization of free fatty acids. In some embodiments, the sodium and potassium salts of the mixtures of fatty acids derived from coconut oil and tallow, i.e., sodium or potassium tallow and coconut soap, are used.

Additional non-soap anionic surfactants which are suitable for use herein include the water-soluble salts, such as the alkali metal, and ammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups.) Non-limiting examples of this group of synthetic surfactants include: a) the sodium, potassium and ammonium alkyl sulfates, especially those obtained by sulfating the higher alcohols (C₈-C₁₈ carbon atoms) such as those produced by reducing the glycerides of tallow or coconut oil; b) sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. In some embodiments, linear straight chain alkylbenzene sulfonates in which the average number of carbon atoms in the alkyl group is from about 11 to 13 (abbreviated as C₁₁₋₁₃ LAS) are used.

Additional anionic surfactants of use include, but are not limited to: alkane sulfonates, olefin sulfonates, fatty acid ester sulfonates, especially methyl ester sulfonates, alkyl phosphonates, alkyl ether phosphonates, sarcosinates, taurates, alkyl ether carboxylates, fatty acid isothionates, sulfosuccinates and the like.

In some embodiments, the anionic surfactants may include C₈-C₂₂ alkyl sulfates, C₈-C₂₂ alkyl alkoxy sulfates, C₈-C₂₂ mid-branched alkyl sulfates, C₁₁-C₁₃ alkyl benzene sulfonate, C₁₂-C₂₀ methyl ester sulfonate, C₁₂-C₁₈ fatty acid soap and combinations thereof.

### II. Fabric Care Agent

“Fabric care agent” as used herein refers to any material that can provide fabric care benefits. Non-limiting examples of fabric care benefits include, but are not limited to: fabric softening; color protection; color restoration; pill/fuzz reduction; anti-abrasion; and anti-wrinkling. In some embodiments, the fabric care benefits are imparted to cotton and cotton-rich garments. Non-limiting examples of fabric care agents include: silicone derivatives; oily sugar derivatives; dispersible polyolefins; polymer latexes; cationic surfactants; and combinations thereof.

a. Silicone Derivatives

For the purposes of the present invention, silicone derivatives may include any silicone material which can deliver fabric care benefits. Silicone derivatives may be incorporated into liquid laundry detergent compositions as emulsions, latexes, dispersions, suspensions and the like in conjunction with suitable surfactants before formulation of the laundry products. Any neat silicone derivatives that are capable of being directly emulsified or dispersed into laundry products are also meant to be encompassed within the present invention since laundry products typically contain a number of different surfactants that can behave like emulsifiers, dispersing agents, suspension agents, etc. thereby aiding in the emulsification, dispersion, and/or suspension of the water insoluble silicone derivatives.

In some embodiments of the present invention, useful silicone derivatives are selected from: polydialkyl siloxane; organofunctional silicones; cyclic silicones; cationic silicones; amino silicones; silicone elastomers; resins; and combinations thereof. In some embodiments, silicones useful in the present invention are those described in: “Silicones-Fields of Application and Technology Trends” by Yoshiaki Ono, Shin-Etsu Silicones Ltd. (Japan); and “Principles of Polymer Science and Technology in Cosmetics and Personal Care”, by M. D. Berthiaume.

In some embodiments, suitable silicones include silicone fluids such as poly(di)alkyl siloxanes, including, but not limited to, polydimethyl siloxanes and cyclic silicones. Poly(di)alkylsiloxanes may be branched, partially crosslinked or linear. Exemplary poly(di)alkylsiloxanes have one of the general formulas (I or II):

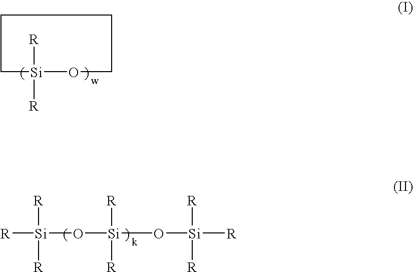

wherein for each structure:
(a) R is a group selected from: a C₁-C₈ alkyl or aryl group, hydrogen, a C₁-C₃ alkoxy or combinations thereof; and
(b) w is from about 3 to about 10 and k is from about 2 to about 10,000.

In some embodiments, polydimethylsiloxane derivatives are of use, including but not limited to, organofunctional silicones. In some embodiments, organofunctional silicones are the “ABn type” silicones disclosed in U.S. Pat. No. 6,903,061, U.S. Pat. No. 6,833,344 and WO 02/018528. Commercially available examples of these silicones are Waro™ and Silsoft™ 843, both of which are available from GE Silicones (Wilton, Conn.).

In some embodiments of the present invention, useful functionalized silicones have the general formula (III):

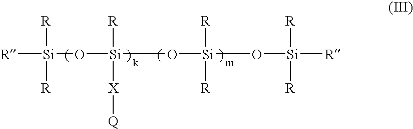

wherein:
(a) each R″ is independently selected from R and —X-Q; wherein:
   (i) R is a group selected from: a C₁-C₈ alkyl or aryl group, hydrogen, a C₁-C₃ alkoxy or combinations thereof;
(b) X is a linking group selected from: an alkylene group —(CH₂)ₚ—; or —CH₂—CH(OH)—CH₂—; wherein:
   (i) p is from 2 to 6,
(c) Q is —(O—CHR₂—CH₂)_{q}-Z; wherein q is on average from about 2 to about 20; and further wherein:
   (i) R₂ is a group selected from: H; a C₁-C₃ alkyl; and
   (ii) Z is a group selected from: —OR₃; —OC(O)R₃; —CO—R₄—COOH; —SO₃; —PO(OH)₂;

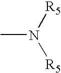

wherein:
   1. R₃ is a group selected from: H; C₁-C₂₆ alkyl or substituted alkyl; C₆-C₂₆ aryl or substituted aryl; C₇-C₂₆ alkylaryl or substituted alkylaryl;
   2. R₄ is a group selected from: —CH₂—; or —CH₂CH₂—;
   3. R₅ is a group independently selected from: H; C₁-C₃ alkyl; —(CH₂)ₚ—NH₂; and —X(—O—CHR₂—CH₂)ₛ-Z; wherein:
      a. p is on average from about 2 to about 6; and
      b. s is on average from about 1 to about 10;

(d) k is on average from about 1 to about 25,000, or from about 3 to about 12,000; and

(e) m is on average from about 4 to about 50,000, or from about 10 to about 20,000.

Commercially available silicones having the general formula III may be selected from: SM2125 and Silwet® 7622, each of which are commercially available from GE Silicones (Wilton, Conn.); DC8822, PP-5495 and DC-5562, all of which are commercially available from Dow Corning (Midland, Mich.); KF-888 and KF-889, both of which are available from Shin Etsu Silicones (Akron, Ohio); Ultrasil® SW-12, Ultrasil® DW-18, Ultrasil® DW-AV, Ultrasil® Q-Plus, Ultrasil® Ca-1, Ultrasil® CA-2, Ultrasil® SA-1 and Ultrasil® PE-100, all of which are available from Noveon Inc. (Cleveland, Ohio); Pecosil® CA-20, Pecosil® SM-40 and Pecosil® PAN-150, all of which are available from Phoenix Chemical Inc. (Somerville, N.J.); and combinations thereof. A further useful commercially available silicone derivate is SLM 21-200, which is commercially available from Wacker Silicones (Adrian, Mich.).

b. Oily Sugar Derivatives

For the purposes of the present invention, oily sugar derivatives include those which can deliver fabric care benefits. Useful oily sugar derivatives include, but are not limited to the general types disclosed in WO 98/16538. Two of the general types of oily sugar derivates are liquid or soft solid derivatives of: a cyclic polyol (hereinafter “CEP”); or a reduced saccharide (RSE); resulting from 35% to 100% of the hydroxyl groups in the CEP or the RSE being esterified and/or etherified. The resultant derivative CPE or RSE has at least two or more of its ester or ether groups independently attached to a C₈ to C₂₂ alkyl or alkenyl chain. Typically CPE's and RSE's have 3 or more ester or ether groups or combinations thereof.

In some embodiments, two or more ester or ether groups of the CPE or RSE may be independently attached to a C₈ to C₂₂ alkyl or alkenyl chain. The C₈ to C₂₂ alkyl or alkenyl chain may be linear or branched. In some embodiments, about 40% to about 100% of the hydroxyl groups are esterified or etherified. In some embodiments, about 50% to about 100% of the hydroxyl groups are esterified or etherified.

In the context of the present invention, the term cyclic polyol encompasses all forms of saccharides. In some embodiments, the CPEs and RSEs are derived from monosaccharides and disaccharides. Non-limiting examples of useful monosaccharides include: xylose; arabinose; galactose; fructose; and glucose. A non-limiting example of a useful saccharide is sorbitan. Non-limiting examples of useful disaccharides include: sucrose; lactose; maltose; and cellobiose.

In some embodiments, the CPEs or RSEs have 4 or more ester or ether groups. If a cyclic CPE is a disaccharide, disaccharide may have three or more ester or ether groups. In some embodiments, sucrose esters with 4 or more ester groups are of use; these are commercially available under the trade name Olean™ from the Procter and Gamble Company (Cincinnati, Ohio).

If a cyclic polyol is a reducing sugar, it may be advantageous if the ring of the CPE has one ether group, preferably at C1 position; the remaining hydroxyl groups are esterified with alkyl groups.
c. Dispersible Polyolefins

For the purposes of the present invention, dispersible polyolefins are those which can deliver fabric care benefits. Useful dispersible polyolefins may be in a form selected from: waxes; emulsions; dispersions; suspensions and combinations thereof.

In some embodiments, the dispersible polyolefin is selected from: polyethylene; polypropylene; and combinations thereof. The polyolefin may be at least partially modified to contain various functional groups including, but not limited to, carboxyl, alkylamide, sulfonic acid or amide groups. In some embodiments, the polyolefin employed in the present invention is at least partially carboxyl modified or, in other words, oxidized. In some embodiments, oxidized or carboxyl modified polyethylene is used in the compositions of the present invention.

For ease of formulation, the dispersible polyolefin may be introduced into the liquid laundry detergent compositions as a suspension or an emulsion of polyolefin dispersed through the use of an emulsifying agent. The polyolefin suspension or emulsion may comprise: from about 1% to about 60%; from about 10% to about 55%; or from about 20% to about 50% by weight of polyolefin. The polyolefin may have a wax dropping point (see ASTM D3954-94, volume 15.04—“Standard Test Method for propping Point of Waxes”) of from about 20° C. to about 170° C. or from about 50° C. to about 140° C. Suitable polyethylene waxes are available commercially from suppliers include, but not limited to: A-C polyethylene from Honeywell (Morristown, N.J.); Velustrol™ emulsion from (Clariant, Mount Holly, N.C.); and LUWAX™ from BASF (Ludwigshafen, Germany).

When an emulsion is employed, the emulsifier may be any suitable emulsification agent including, but not limited to: anionic surfactant; cationic surfactant; nonionic surfactant; or combinations thereof. The dispersible polyolefin is dispersed by use of an emulsifier or suspending agent in a ratio of from about 1:100 to about 1:2, or from about 1:50 to about 1:5.

d. Polymer Latexes

For the purposes of the present invention, polymer latexes include those which can deliver fabric care benefits. Polymer latexes are typically made by an emulsion polymerization process which includes one or more monomers, one or more emulsifiers, an initiator, and other components familiar to those of ordinary skill in the art. All polymer latexes that provide fabric care benefits can be used as fabric care agents of the present invention. Non-limiting examples of suitable polymer latexes include those disclosed in WO 02/018451. Additional non-limiting examples include polymer latexes such as these, which are made from the monomers:
1) 100% butylacrylate;
2) Butylacrylate and butadiene combinations with at least about 20% (weight monomer ratio) of butylacrylate;
3) Butylacrylate and less than about 20% (weight monomer ratio) of other monomers excluding butadiene;
4) Alkylacrylate with an alkyl carbon chain at or greater than C6;
5) Alkylacrylate with an alkyl carbon chain at or greater than C6 and less than 50% (weight monomer ratio) of other monomers;
6) A third monomer (less than about 20% weight monomer ratio) added into monomer systems from (1) to (5)

Polymer latexes that are suitable fabric care agents in the present invention include those having a glass transition temperature of from about −120° C. to about 120° C., or from about −80° C. to about 60° C. Suitable emulsifiers include anionic, cationic, nonionic and amphoteric surfactants. Suitable initiators include all initiators that are suitable for emulsion polymerization of polymer latexes. The particle size of the polymer latexes can be from about 1 nanometer (nm) to about 10 micrometers (μm), or from about 10 nanometers (nm) to about 1 (μm).

e. Cationic Surfactants

For the purposes of the present invention, cationic surfactants include those which can deliver fabric care benefits. Non-limiting examples of useful cationic surfactants include: fatty amines; quaternary ammonium surfactants; and imidazoline quat materials.

In some embodiments, useful cationic surfactants, include those disclosed in U.S. Patent Application number 2005/0164905 A1 and having the general formula (IV):

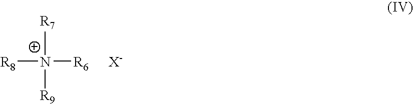

wherein:
(a) R₆ and R₇ each are individually selected from the groups of: C₁-C₄ alkyl; C₁-C₄ hydroxy alkyl; benzyl; —(CₙH₂ₙO)ₓH, wherein:
   i. x has a value from about 2 to about 5;
   ii. n has a value of about 1-4;
(b) R₈ and R₉ are each:
   i. a C₈-C₂₂ alkyl; or
   ii. R₈ is a C₈-C₂₂ alkyl and R₄ is selected from the group of: C₁-C₁₀ alkyl; C₁-C₁₀ hydroxy alkyl; benzyl; —(CₙH₂ₙO)ₓH, wherein:
      1. x has a value from 2 to 5; and
      2. n has a value of 1-4; and
(c) X is an anion.

In some embodiments, useful cationic surfactants include, but are not limited to, imidazoline derivatives having the general formula (V):

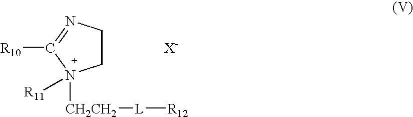

wherein:
(a) R₁₀ is a C₈-C₂₂ alkyl or alkylaryl group;
(b) R₁₁ and R₁₂ are independently selected from H, or C₁-C₂₂ alkyl; and
(c) L is selected from:

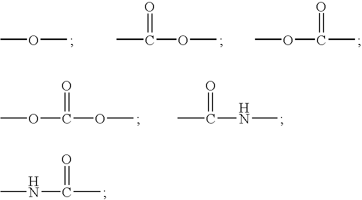

urethane radicals; and urea radicals;
(d) X⁻ is an anion.

### III. Cationic Deposition Aid

As used herein, “cationic deposition aid” refers to any cationic polymer or combination of cationic polymers that enhance the deposition of fabric care agent(s) onto fabric during laundering. Without wishing to be bound by theory, it is believed that in order to drive the fabric care agent onto the fabric, the net charge of the deposition aid is positive in order to overcome the repulsion between the fabric care agent and the fabric since most fabrics are comprised of fabric fibers that have a slightly negative charge in aqueous environments. Examples of fibers exhibiting a slightly negative charge in water include but are not limited to cotton, rayon, silk, wool, and the like.

Effective deposition aids are typically characterized by a strong binding capability with the present fabric care agents via physical forces such as: van der Waals forces; non-covalent chemical bonds such as hydrogen bonding; and/or ionic bonding. In some embodiments, deposition aids also have a strong affinity to natural fabric fibers, such as cotton fibers for example.

The present cationic deposition aids are water soluble and have flexible molecular structures such that they may associate with the surface of a fabric care agent particle or hold several of the particles together. Therefore, the deposition enhancing agent is typically not cross-linked and typically does not have a network structure as both of these characteristics may lead to a lack of molecular flexibility.

Non-limiting examples of useful deposition aids include cationic or amphoteric polymers. The amphoteric polymers of the present invention may have a net cationic charge, i.e., the total cationic charge of an amphoteric polymer will exceed the total anionic charge. The cationic charge density of the cationic deposition aid may range from about 0.05 milliequivalents/g to about 12 milliequivalents/g of the polymer. The charge density is calculated by dividing the number of net charges per repeating unit by the molecular weight of the repeating unit. In one embodiment, the charge density varies from about 0.1 milliequivalents/g to about 3 milliequivalents/g. The positive charges may be located on the backbone of the polymers and/or the side chains of polymers.

Nonlimiting examples of deposition enhancing agents are cationic polysaccharides, chitosan and its derivatives and synthetic cationic polymers.

a. Cationic Polysaccharides

Cationic polysaccharides of use in the present invention include, but are not limited to: cationic cellulose derivatives; cationic guar gum derivatives; chitosan and derivatives; and cationic starches. Useful cationic polysaccharides may have a weight average molecular weight of from about 50,000 Daltons (Da) to about 2 million Da, or from about 100,000 Da to about 1,000,000 Da. Useful cationic celluloses may have a molecular weight of from about 200,000 to about 800,000, and cationic guars may have a molecular weight of from about 500,000 to 1.5 million.

In some embodiments, useful cationic polysaccharides are those disclosed in U.S. Pat. Nos. 6,833,347 and 7,056,880. In some embodiments, useful cationic starches include those disclosed in “Modified Starches, Properties and Uses”, by D. B. Solarek (CRC Press (1986)). Non-limiting examples of cationic starches of use include the Cato™ cationic starches, which are commercially available from National Starch and Chemical Company (Brookfield, Ohio).

In some embodiments of the present invention, cationic polysaccharides of use may be cationic guar derivatives having the following general formula (VI):

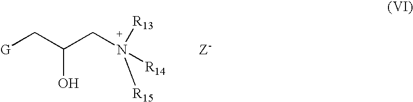

wherein:
(a) G is the glactaomanan backbone;
(b) R₁₃ is a group selected from: CH₃; CH₂CH₃; a phenyl group; a C₈₋₂₄ alkyl group (linear or branched); and combinations thereof;
(c) R₁₄ and R₁₅ are groups independently selected from: CH₃; CH₂CH₃; phenyl; and combinations thereof; and
(d) Z⁻ is a suitable anion.

In some embodiments of the present invention, the guar derivatives include guar hydroxypropyltrimethyl ammonium chloride. Examples of cationic guar gums are Jaguar™ C13 and Jaguar™ Excel available from Rhodia, Incorporated (Cranburry N.J.).

b. Synthetic Cationic Polymers

Cationic polymers in general and their method of manufacture are known in the literature. For example, a detailed description of cationic polymers can be found in the article by M. Fred Hoover published in the Journal of Macromolecular Science-Chemistry, A4(6), pp 1327-1417, October, 1970. Other suitable synthetic cationic polymers are those used as retention aids in the manufacture of paper, which are described in “Pulp and Paper, Chemistry and Chemical Technology Volume III”, edited by James Casey (1981). The weight average molecular weight of these polymers may be in the range of from about 2,000 to about 5 million.

b-i). One group of useful synthetic cationic polymers includes those produced by polymerization of ethylenically unsaturated monomers using a suitable initiator or catalyst. These are disclosed in WO 00/56849 and U.S. Pat. No. 6,642,200. In some embodiments, the cationic synthetic polymers is a polymer made by copolymerizing:
1) one or more cationic monomers selected from a group consisting N,N-dialkylaminoalkyl methacrylate, N,N-dialkylaminoalkyl acrylate, N,N-dialkylaminoalkyl acrylamide, N,N-dialkylaminoalkylmethacrylamide, their quaternized derivatives, vinylamine and its derivatives, allylamine and its derivatives, vinyl imidazole, quaternized vinyl imidazole and quaternized diallyl dialkyl ammonium and its derivatives; and
2) one or more neutral monomers selected from a group consisting of acrylamide (AM), N,N-dialkyl acrylamide, methacrylamide, N,N-dialkylmethacrylamide, C1-C12 alkyl acrylate, C1-C12 hydroxyalkyl acrylate, C1-C12 hydroxyetheralkyl acrylate, C1-C12 alkyl methacrylate, C1-C12 hydroxyalkyl methacrylate, vinyl acetate, vinyl alcohol, vinyl formamide, vinyl acetamide, vinyl alkyl ether, vinyl butyrate and derivatives;

Non-limiting examples of useful cationic monomers include: N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride (MAPTAC), quaternized vinyl imidazole and diallyldimethylammonium chloride and derivatives thereof. Neutral monomers of use include: acrylamide, N,N-dimethyl acrylamide, C1-C4 alkyl acrylate, C1-C4 hydroxyalkylacrylate, vinyl formamide, vinyl acetate, and vinyl alcohol. Most preferred nonionic monomers are acrylamide, hydroxyethyl acrylate (HEA), hydroxypropyl acrylate and derivative thereof,

The polymer may optionally comprise anionic monomers, including but not limited to: acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include, but are not limited to, ethylene glycoldiacrylatate divinylbenzene, and butadiene.

In some embodiments, the polymers of use include: poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride) and combinations thereof.

b-ii) Another group of useful synthetic cationic polymers are polyethyleneimine and its derivatives. These are commercially available under the trade name Lupasol ex. BASF AG (Ludwigshafen, Germany).

b-iii) A third group of useful synthetic cationic polymers are polyamidoamine-epichlorohydrin (PAE) resins which are condensation products of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™. These polymers are described in Wet Strength resins and their applications edited by L. L. Chan, TAPPI Press (1994).

In order for the deposition polymers to be formulable and stable in the present compositions, it is important that the monomers are incorporated in the polymer to form a copolymer. This may especially be true when monomers have widely different reactivity ratios are used. In contrast to the commercial copolymers, the deposition polymers herein have a free monomer content less than 10%, preferably less than 5%, by weight of the monomers.

The deposition assisting polymers can be random, blocky or grafted. They can be linear or branched. The deposition assisting polymers comprises from about 1 to about 60 mol percent, or from about 1 to about 40 mol percent, of the cationic monomer repeat units and from about 98 to about 40 mol percent, from about 60 to about 95 mol percent, of the nonionic monomer repeat units.

The deposition assisting polymer may have a charge density of about 0.01 to about 12.0 milliequivalents/g (meq/g) of dry polymer, preferably about 0.2 to about 3 meq/g; this refers to the charge density of the polymer itself and is often different from the monomer feedstock. For example, for the copolymer of acrylamide and diallyldimethylammonium chloride with a monomer feed ratio of 70:30, the charge density of the feed monomers is about 3.05 meq/g. However, if only 50% of diallyldimethylammonium is polymerized, the polymer charge density is only about 1.6 meq/g. The polymer charge density is measured by dialyzing the polymer with a dialysis membrane or by NMR. For polymers with amine monomers, the charge density depends on the pH of the carrier. For these polymers, charge density is measured at a pH of 7.

The weight-average molecular weight of the polymer will generally be between 10,000 and 5,000,000, preferably from 100,000 to 2,00,000 and even more preferably from 200,000 and 1,500,000, as determined by size exclusion chromatography relative to polyethyleneoxide standards with RI detection. The mobile phase used is a solution of 20% methanol in 0.4M MEA, 0.1 M NaNO₃, 3% acetic acid on a Waters Linear Ultrahdyrogel column, 2 in series. Columns and detectors are kept at 40° C. Flow is set to 0.5 mL/min.

### IV. Performance Booster

As noted infra, “performance booster” as used herein refers to any material useful in a liquid laundry detergent composition to increase cleaning, which does not “negatively interact” with cationic deposition aid and/or fabric care agent. The performance boosters may provide benefits selected from the non-limiting group of: stain removal; whiteness maintenance; stain release; and combinations thereof. The performance boosting agents of the current invention may be selected from: anionic dispersants; brighteners; enzymes; and combinations thereof.

a. Anionic Dispersants

Suitable anionic polymers include: random co-polymers; block co-polymers; and combinations thereof. Such polymers typically comprise first and second moieties in a ratio of from about 100:1 to about 1:5. Suitable first moieties include moieties derived from monoethylenically unsaturated C₃-C₈ monomers comprising: at least one carboxylic acid group; salts of such monomers; and combinations thereof. Non-limiting examples of suitable monomers include monoethylenically unsaturated C₃-C₈ monocarboxylic acids and C₄-C₈ dicarboxylic acids selected from the group of: acrylic acid; methacrylic acid; beta-acryloxypropionic acid; vinyl acetic acid; vinyl propionic acid; crotonic acid; ethacrylic acid; alpha-chloro acrylic acid; alpha-cyano acrylic acid; maleic acid; maleic anhydride; fumaric acid; itaconic acid; citraconic acid; mesaconic acid; methylenemalonic acid; their salts; and combinations thereof. In some embodiments of the invention, suitable first moieties comprise monomers that are entirely selected from the group of: acrylic acid; methacrylic acid; maleic acid; and combinations thereof.

Suitable second moieties include:
1.) Moieties derived from modified unsaturated monomers having the formula R—Y-L and R-Z wherein:
   a.) R has the structure C(X)H═C(R¹)—, wherein
      (i) R¹ is H, or C₁-C₄ alkyl; and
      (ii) X is H, CO₂H, or CO₂R₂ wherein R₂ is selected from the group of: hydrogen, alkali metals, alkaline earth metals, ammonium and amine bases, saturated C₁-C₂₀ alkyl, C₆-C₁₂ aryl, and C₇-C₂₀ alkylaryl;
   b.) Y is selected from the group of: —CH₂—, —CO₂—, —OCO—, and —CON(R^{a})—, —CH₂OCO—; wherein R^{a} is H or C₁-C₄ alkyl;
   c.) L is selected from the group of: hydrogen, alkali metals, alkaline earth metals, ammonium and amine bases, saturated C₁-C₂₀ alkyl, C₆-C₁₂ aryl, and C₇-C₂₀ alkylaryl; and
   d.) Z is selected from the group of: C₆-C₁₂ aryl and C₇-C₁₂ arylalkyl.

Suitable anionic polymers comprising such first and second moieties typically have weight-average molecular weights of from about 1000 Da to about 100,000 Da. Examples of such polymers include: Alcosperse® 725 and Alcosperse® 747 available from Alco Chemical (Chattanooga, Tenn.); and Acusol® 480N from Rohm & Haas Co. (Spring House, Pa.).

Another class of suitable second moieties includes moieties derived from ethylenically unsaturated monomers containing from about 1 to about 100 repeat units selected from the group of: C₁-C₄ carbon alkoxides; and combinations thereof. An example of such an unsaturated monomer is represented by the formula J-G-D wherein:
1.) J is selected from the group consisting of C(X) H═C(R₁)— wherein
   a.) R₁ is H, or C₁-C₄ alkyl;
   b.) X is H, CO₂H, or CO₂R₂ wherein R₂ is hydrogen, alkali metals, alkaline earth metals, ammonium and amine bases, saturated C₂-C₂₀ alkyl, C₆-C₁₂ aryl, C₇-C₂₀ alkylaryl;
2.) G is selected from the group of: C₁-C₄ alkyl, —O—, —CH₂O—, —CO₂—.
3.) D is selected from the group of:
   a.) —CH₂CH(OH)CH₂O(R³O)_{d}R⁴;
   b.) —CH₂CH[O(R³O)_{d}R⁴]CH₂OH;
   c.) —CH₂CH(OH)CH₂NR⁵(R³O)_{d}R⁴;
   d.) —CH₂CH[NR⁵(R³O)_{d}R⁴]CH₂OH, and combinations thereof; wherein
R³ is selected from the group of: ethylene, 1,2-propylene, 1,3-propylene, 1,2-butylene, 1,4-butylene, and combinations thereof;
R⁴ is a capping unit selected from the group of: H, C₁-C₄ alkyl, C₆-C₁₂ aryl and C₇-C₂₀ alkylaryl;
R⁵ is selected from the group of: H, C₁-C₄ alkyl C₆-C₁₂ aryl and C₇-C₂₀ alkylaryl; and subscript index d is an integer from 1 to 100.

In another aspect of Applicants' invention:
1.) J is selected from the group of: C(X) H═C(R¹)— wherein
   a.) R¹ is H, or C₁-C₄ alkyl;
   b.) X is H or CO₂H;
2.) G is selected from the group of: —O—, —CH₂O—, —CO₂—.
3.) D is selected from the group of:
   a.) —CH₂CH(OH)CH₂O(R³O)_{d}R⁴;
   b.) —CH₂CH[O(R³O)_{d}R⁴]CH₂OH, and combinations thereof; wherein
R³ is ethylene;
R⁴ is a capping unit selected from the group of: H, and C₁-C₄ alkyl; and
d is an integer from 1 to 100.

In still another aspect of Applicants' invention the variables J, D, R³ and d are as described immediately above and the variables R¹ and X are H, G is —CO₂—. and R⁴ is C₁-C₄ alkyl.

Suitable anionic polymers comprising such first and second moieties typically have weight-average molecular weights of from about 2000 Da to about 100,000 Da. Examples of such polymers include the IMS polymer series supplied by Nippon Shokubai Co., Ltd (Osaka, Japan).

Other suitable anionic polymers include graft co-polymers that comprise the first moieties previously described herein, and which typically have weight-average molecular weights of from about 1000 Da to about 50,000 Da. In such polymers, the aforementioned first moieties are typically grafted onto a C₁-C₄ carbon polyalkylene oxide. Examples of such polymers include the PLS series from Nippon Shokubai Co., Ltd (Osaka, Japan).

Other suitable anionic polymers include Sokalan® ES 8305, Sokalan® HP 25, and Densotan®, which are all supplied by BASF Corporation (Ludwigshafen, Germany).

b. Brighteners

“Brightener” (also referred to as “optical brightener”) is used herein in the broadest sense to include any compound that exhibits fluorescence, including compounds that absorb UV light and reemit as “blue” visible light.

Suitable brighteners include fluorescent whitening agents and are more fully described in the following: (1) “Ullman's Encyclopedia of Industrial Chemistry” Fifth Edition, Vol. A18, Pages 153 to 176; (2) “Kirk-Othmer Encyclopedia of Chemical Technology”, Volume 11, Fourth Edition; and (3) “Fluorescent Whitening Agents”, Guest Editors R. Anliker and G. Muller, Georg Thieme Publishers Stuttgart (1975). In some embodiments of the present invention, brighteners are also low in color or colorless and do not absorb materially in the visible part of the spectrum. In some embodiments, brighteners are also light fast, meaning they do not degrade substantially in sunlight.

Brighteners suitable for use in the present invention absorb light in the ultraviolet portion of the spectrum between about 275 nm and about 400 nm and emit light in the violet to violet-blue range of the spectrum from about 400 nm to about 500 nm. In some embodiments, the brighteners will contain an uninterrupted chain of conjugated double bonds. Non-limiting examples of useful brighteners include: derivatives of stilbene or 4,4′-diaminostilbene, biphenyl, five-membered heterocycles such as triazoles, oxazoles, imidiazoles, etc., or six-membered heterocycles (coumarins, naphthalamide, s-triazine, etc.). Cationic, anionic, nonionic, amphoteric and zwitterionic brighteners can be used. Cationic brighteners used since they can compete effectively with the cationic fabric softener actives to partition to the surface of the fabric. Both cationic and nonionic brighteners are utilized so they do not negatively interact with other ingredients in the cationic fabric conditioning composition. For example, anionic brighteners, while still very usable and can provide a good whitening benefit, can interact with a cationic component in the fabric conditioning composition such as cationically substituted starch or other cationic polymers. The effect can be that the anionic brightener can negate some or all of the softening effect provided by the cationic starch or other cationic polymers.

Brighteners, which also can provide a dye transfer inhibition action, of use in the present invention include, but are not limited to those having the general structural formula:

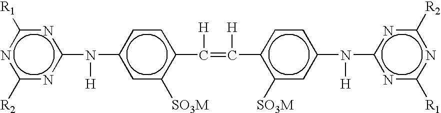

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the trade name Tinopal-UNPA-GX® by Ciba Specialty Chemicals Corporation (High Point, N.C.).

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX® (by Ciba Specialty Chemicals Corporation (High Point, N.C.).

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX® by Ciba Specialty Chemicals Corporation (High Point, N.C.).

Brighteners should have some water solubility for easy incorporation into the fabric conditioning composition. For example the water solubility (deionized water) of the brightener should be at least about 0.5 weight percent at 25° C., or at least about 2 weight percent. Fluorescent whitening agents, generally due to their low water solubility, are difficult to incorporate into liquid fabric conditioning compositions. Often it is advantageous to post-add brighteners to a finished base product. One convenient way to do this is to make a brighteners premix.

It has surprisingly been found that ethoxylated monoalkyl quaternary surfactants are particularly good solvents for dissolving anionic brighteners such as Tinopal™ CBS-X in water. Recall that these surfactants are also surprisingly effective at reducing fabric staining when incorporated into a fabric conditioning composition with hueing dyes. Particularly effective is Ethoquad™ C/25 (cocomethyl ethoxylated [15] ammonium chloride) from Akzo Nobel. Its nominal structure was shown earlier (in section: entitled “Surfactants as Stain-Reducing Agents”).

Fluorescent whitening agents of use in the present invention may be selected from, but are not limited to: disodium 4,4′-bis-(2-sulfostyryl) biphenyl (marketed by Ciba™ Specialty Chemicals (High Point, N.C.) as Tinopal™ CBS-X); Benzenesulfonic acid, 2,2′-(1,2-ethenediyl)bis[5-[4-[(2-hydroxyethyl)methylamino]-6-(phenylamino)-1,3,5-triazin-2-y]amino]-, disodium salt marketed by Ciba™ Specialty Chemicals (High Point, N.C.) as Tinopal™ DCS); Disodium 4,4′-bis{[4-anilino-6-[bis(2-hydroxyethyl)amino-s-triazin-2-yl]-amino}-2,2′-stilbenedisulfonate (marketed by Ciba™ Specialty Chemicals (High Point, N.C.) as Tinopal™ UNPA-GX); Disodium 4,4′-bis[(4-anilino-6-(N-2-hydroxyethyl-N-methylamino)-s-triazine-2-yl)amino]2,2′-stilbenedisulfonate (marketed by Ciba™ Specialty Chemicals (High Point, N.C.) as Tinopal™ 5BM-GX); disodium 4,4′-bis{[4-anilino-6-methylamino-s-triazin-2-yl]-amino]-2,2′-stilbenedisulfonate (marketed by Bayer AG (Leverkusen, Germany) as Blankophor HRS; disodium 4,4″-bis[4,6-di-anilino-s-triazin-2-yl]-2,2′-stilbenedisulfonate (marketed by Ciba™ Specialty Chemicals (High Point, N.C.) as Tinopal™ TAS); disodium 4,4′-bis{[4-anilino-6-morpholino-s-triazin-2-yl}-amino}-2,2′-stilbenedisulfonate (marketed by Ciba™ Specialty Chemicals (High Point, N.C.) as Tinopal™ AMS-GX); and combinations thereof.

In some embodiments, Tinopal™ CBS-X brightener is utilized due to the advantages it provides including, but not limited to: a water solubility of about 2.5 weight percent at 25° C.; and maintenance of chemical stability in the acidic product matrix of biodegradable fabric conditioning compositions (e.g., pH is from about 3 to about 4).

c. Detersive Enzymes

Enzymes can be included in the present compositions for a wide variety of fabric laundering purposes including, but not limited to removal of protein-based, carbohydrate-based, or triglyceride-based stains, and/or for fabric restoration. Examples of suitable enzymes include, but are not limited to: hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, and combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. In some embodiments, the enzyme combination comprises a cocktail of conventional detersive enzymes like protease, lipase, cutinase and/or cellulase in conjunction with amylase. Detersive enzymes are described in greater detail in U.S. Pat. No. 6,579,839. In some embodiments, the compositions herein contain from about 0.05% to about 2% by weight of detersive enzymes.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, or from about 0.01% to 1% by weight of a commercial enzyme preparation. Protease enzymes are usually present in such commercial preparations at levels sufficient to provide from 0.005 to 0.1 Anson units (AU) of activity per gram of composition.

Proteases useful herein include those like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants [Henkel]. Further proteases are described in EP130756, WO91/06637, WO95/10591 and WO99/20726.

Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Amylases also include, for example, α-amylases described in British Patent Specification No. 1,296,839 (Novo), RAPIDASE, International Bio-Synthetics, Inc.

Suitable lipases include those produced by Pseudomonas and Chromobacter groups. The LIPOLASE enzyme derived from Humicola lanuginosa and commercially available from Novo (see also EPO 41,947) is a preferred lipase for use herein. Also preferred are e.g., Lipolase Ultra®, Lipoprime® and Lipex® from Novozymes. Also suitable are cutinases [EC 3.1.1.50] and esterases. See also lipases in Japanese Patent Application 53,20487, laid open to public inspection on Feb. 24, 1978. This lipase is available from Areario Pharmaceutical Co. Ltd., Nagoya, Japan, under the trade name Lipase P “Amano,” hereinafter referred to as “Amano-P.” Other commercial lipases include Amano-CES, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Diosynth Co., The Netherlands, and lipases ex Pseudomonas gladioli.

Carbohydrases useful herein include e.g. mannanase (for example, those disclosed in U.S. Pat. No. 6,060,299), pectate lyase (for example, those disclosed in PCT Application WO99/27083), cyclomaltodextringlucanotransferase (for example, those disclosed in PCT Application WO96/33267), xyloglucanase (for example, those disclosed in PCT Application WO99/02663).

Cellulases usable herein include both bacterial and fungal types, typically having a pH optimum between 5 and 10. U.S. Pat. No. 4,435,307, Barbesgoard et al., Mar. 6, 1984, discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME® ENDOLASE and CELLUZYME®, (Novozymes, Copanhagen Denmark) are especially useful. See also WO 9117243 to Novozymes. Also suitable cellulases are the EGIII cellulases from Trichoderma longibrachiatum.

Bleaching enzymes useful herein with enhancers include e.g. peroxidases, laccases, oxygenases, (e.g. catechol 1,2 dioxygenase, lipoxygenase (for example, those disclosed in PCT Application WO 95/26393), (non-heme) haloperoxidases.

Enzyme Stabilizer

If an enzyme or enzymes are included in the compositions of the present invention, the composition may also contain an enzyme stabilizer. Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts, (meth)acrylic acid-(meth)acrylic acid ester copolymer and PEG, lignin compound, polyamide oligomer, glycolic acid or its salts, poly hexa methylene biguanide or N,N-bis-3-amino-propyl-dodecyl amine or salt, and combinations thereof.

Additional stability can be provided by the presence of various other an-disclosed stabilizers, especially borate species as disclosed in U.S. Pat. No. 4,537,706. Typical detergents, especially liquids, will comprise from about 1 to about 30, from about 2 to about 20, from about 5 to about 15, or from about 8 to about 12, millimoles of calcium ion per liter of finished composition. This can vary somewhat, depending on the amount of enzyme present and its response to the calcium or magnesium ions. Any water-soluble calcium or magnesium salt can be used as the source of calcium or magnesium ions, including, but not limited to, calcium chloride, calcium sulfate, calcium malate, calcium maleate, calcium hydroxide, calcium formate, and calcium acetate, and the corresponding magnesium salts. A small amount of calcium ion, generally from about 0.05 to about 0.4 millimoles per liter, is often also present in the composition due to calcium in the enzyme slurry and formula water. In solid detergent compositions the formulation may include a sufficient quantity of a water-soluble calcium ion source to provide such amounts in the laundry liquor. In the alternative, natural water hardness may suffice.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from about 0.05% to about 2% by weight of a water-soluble source of calcium or magnesium ions, or both. The amount can vary, of course, with the amount and type of enzyme employed in the composition.

In a liquid composition, the degradation by the proteolytic enzyme of second enzymes can be avoided by protease reversible inhibitors [e.g. peptide or protein type, in particular the modified subtilisin inhibitor of family VI and the plasminostrepin; leupeptin, peptide trifluoromethyl ketones, peptide aldehydes.

### V. Laundry Adjunct

Laundry adjuncts of use in the present invention may provide for pleasing aesthetic benefits relating, but not limited to liquid laundry detergent composition: appearance; aroma; and rheology. Useful laundry adjuncts include, but are not limited to: pearlescent agent; surfactant (excluding anionic surfactant); builder; polymeric soil release agent; and combinations thereof.

a. Pearlescent Agent

The pearlescent agents according to the present invention may be crystalline or glassy solids, transparent or translucent compounds capable of refracting light to produce a pearlescent effect. Typically, the pearlescent agents are crystalline particles insoluble in the composition in which they are incorporated. In some embodiments, the pearlescent agents have the shape of thin plates or spheres. Spheres according to the present invention are to be interpreted as generally spherical. Particle size is measured across the largest diameter of the sphere. Plate-like particles are such that two dimensions of the particle (length and width) are at least 5 times the third dimension (depth or thickness). Other crystal shapes like cubes or needles or other crystal shapes typically do not display pearlescent effect. Many pearlescent agents like mica are natural minerals having monoclinic crystals. Shape appears to affect the stability of the agents. The spherical, even more preferably, the plate-like agents being the most successfully stabilised.

Pearlescent agents are known in the literature, but generally for use in shampoo, conditioner or personal cleansing applications. They are described as materials which impart, to a composition, the appearance of mother of pearl. The mechanism of pearlescence is described by R. L. Crombie in International Journal of Cosmetic Science Vol 19, page 205-214. Without being wishing to be bound by theory, it is believed that pearlescence is produced by specular reflection of light as shown in the figure below. Light reflected from pearl platelets or spheres as they lie essentially parallel to each other at different levels in the composition creates a sense of depth and luster. Some light is reflected off the pearlescent agent, and the remainder will pass through the agent. Light passing through the pearlescent agent, may pass directly through or be refracted. Reflected, refracted light produces a different colour, brightness and luster. The Applicants have found that the best luster, brightness, and color intensity occurs with pearlescent agents that have D0.99 of less than 30 microns. In some embodiments, the pearlescent agents have average particle length (largest dimension) of from 10 to 20 microns. Smaller platelets impart a smooth, silky luster, and larger ones confer sparkle and glitter.

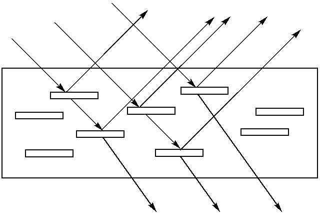

The pearlescent agents may be organic or inorganic. The pearlescent agents may have D0.99 volume particle size of less than 60 μm. In some embodiments, the pearlescent agents have D0.99 of less than 50 μm, less than 40 μm, or less than 30 μm. In some embodiments, the pearlescent agent has a particle size distribution of from about 0.1 μm to 50 μm, from about 0.5 μm to 25 μm, or from about 1 μm to 20 μm. The D0.99 is a measure of particle size relating to particle size distribution and meaning 99% of the particles have volume particle size of less than 60 μm. Volume particle size and particle size distribution are measured using the Hydro 2000G equipment available from Malvern Instruments Ltd. Particle size has a role in stabilization of the agents. The smaller the particle size and distribution, the more easily they are suspended.

The pearlescent agents have a refractive index of more than about 1.41, more than about 1.8, or more than about 2.0. In some embodiments, the difference in refractive index between the pearlescent agent and the composition or medium, to which pearlescent agent is then added, is at least about 0.02. In some embodiments, the difference in refractive index between the pearlescent agent and the composition is at least about 0.2, or at least about 0.6.

The liquid compositions of the present invention may comprise from about 0.01% to 15.0% by weight of the composition of a 100% active pearlescent agent. In some embodiments, the liquid composition comprises from about 0.01% to 5%, from about 0.01% to 3.0%, or from about 0.01% to 0.5% by weight of the composition of the 100% active pearlescent agents, most preferably from 0.02% to 0.2% by weight of the composition.

### Organic Pearlescent Agents:

Suitable pearlescent agents include monoester and/or diester of alkylene glycols having the formula:

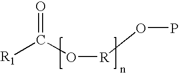

wherein:
a. R₁ is linear or branched C12-C22 alkyl group;
b. R is linear or branched C2-C4 alkylene group;
c. P is selected from the group of: H; Cb 1-C4 alkyl; or —COR₂; and
d. n=1-3.

In one embodiment of the present invention, the long chain fatty ester has the general structure described above, wherein R₁ is linear or branched C16-C22 alkyl group, R is —CH₂—CH₂—, and P is selected from H, or —COR₂, wherein R₂ is C4-C22 alkyl, preferably C12-C22 alkyl.

Typical examples are monoesters and/or diesters of ethylene glycol, propylene glycol, diethylene glycol, dipropylene glycol, triethylene glycol or tetraethylene glycol with fatty acids containing from about 6 to about 22, preferably from about 12 to about 18 carbon atoms, such as caproic acid, caprylic acid, 2-ethyhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid, erucic acid, and mixtures thereof.

In one embodiment, ethylene glycol monostearate (EGMS) and/or ethylene glycol distearate (EGDS) and/or polyethylene glycol monostearate (PGMS) and/or polyethyleneglycol distearate (PGDS) are the pearlescent agents used in the composition. There are several commercial sources for these materials. For example, PEG6000MS® is available from Stepan, Empilan EGDS/A® is available from Albright & Wilson.

### Inorganic Pearlescent Agents:

Inorganic pearlescent agents include those selected from the group consisting of mica, metal oxide coated mica, silica coated mica, bismuth oxychloride coated mica, bismuth oxychloride, myristyl myristate, guanine, glitter (polyester or metallic) and mixtures thereof.

Suitable micas includes muscovite or potassium aluminum hydroxide fluoride. The platelets of mica are preferably coated with a thin layer of metal oxide. Preferred metal oxides are selected from the group consisting of rutile, titanium dioxide, ferric oxide, tin oxide, alumina and mixtures thereof. The crystalline pearlescent layer is formed by calcining mica coated with a metal oxide at about 732° C. The heat creates an inert pigment that is insoluble in resins, has a stable color, and withstands the thermal stress of subsequent processing

More preferably inorganic pearlescent agents are selected from the group consisting of mica and bismuth oxychloride and mixtures thereof. Most preferably inorganic pearlescent agents are mica. Commercially available suitable inorganic pearlescent agents are available from Merck under the tradenames Iriodin, Biron, Xirona, Timiron Colorona, Dichrona, Candurin and Ronastar. Other commercially available inorganic pearlescent agent are available from BASF (Engelhard, Mearl) under tradenames Biju, Bi-Lite, Chroma-Lite, Pearl-Glo, Mearlite and Eckart under the tradenames Prestige Soft Silver and Prestige Silk Silver Star.

b. Surfactant

The laundry products of the present invention may comprise from about 1% to 50% by weight of a nonionic, zwitterionic, or ampholytic surfactant. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980.

Useful nonionic surfactants include, but are not limited to C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), block alkylene oxide condensate of C₆ to C₁₂ alkyl phenols, alkylene oxide condensates of C₈-C₂₂ alkanols and ethylene oxide/propylene oxide block polymers (Pluronic™-BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants in the compositions of the invention.

Also suitable are alkyl polyglucoside surfactants.

In some embodiments, nonionic surfactants of use include those of the formula R¹(OC₂H₄)ₙOH, wherein R¹ is a C₁₀-C₁₆ alkyl group or a C₈-C₁₂ alkyl phenyl group, and n is from 3 to about 80. In some embodiments, the nonionic surfactants may be condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol

Additional suitable nonionic surfactants include polyhydroxy fatty acid amides of the formula:

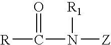

wherein R is a C₉₋₁₇ alkyl or alkenyl, R₁ is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798.

c. Builder

The liquid laundry detergent compositions of the present invention may also comprise from about 0.1% to about 80% by weight of a builder. Such compositions in liquid form will comprise from about 1% to 10% by weight of the builder component. Such compositions in a gel form may comprise from about 0.5 to about 30% by weight of builder. Detergent builders may comprise, for example, phosphate salts as well as various organic and inorganic nonphosphorus builders.

Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid. Other suitable polycarboxylates for use herein are the polyacetal carboxylates described in U.S. Pat. Nos. 4,144,226 and 4,246,495. In some embodiments, polycarboxylate builders are the oxydisuccinates and the ether carboxylate builder compositions comprising a combination of tartrate monosuccinate and tartrate disuccinate described in U.S. Pat. No. 4,663,071.

Non-limiting examples of suitable nonphosphorus, inorganic builders include the silicates, aluminosilicates, borates and carbonates. In some embodiments, the inorganic builders are selected from: sodium and potassium carbonate, bicarbonate, sesquicarbonate, tetraborate decahydrate, and silicates having a weight ratio of SiO₂ to alkali metal oxide of from about 0.5 to about 4.0, or from about 1.0 to about 2.4. Also preferred are aluminosilicates including zeolites. Such materials and their use as detergent builders are more fully discussed in U.S. Pat. No. 4,605,509. Also, crystalline layered silicates such as those discussed in U.S. Pat. No. 4,605,509 are suitable for use in the liquid laundry detergent compositions of this invention.

d. Polymeric Soil Release Agent

Known polymeric soil release agents, hereinafter “SRA” or “SRA's”, can optionally be employed in the present liquid laundry detergent compositions. If utilized, SRA's will generally comprise from about 0.01% to about 10.0%, from about 0.1% to about 5%, or from about 0.2% to about 3.0% by weight, of the composition.

In some embodiments, SRA's may have hydrophilic segments to hydrophilize the surface of hydrophobic fibers such as polyester and nylon, and hydrophobic segments to deposit upon hydrophobic fibers and remain adhered thereto through completion of washing and rinsing cycles thereby serving as an anchor for the hydrophilic segments. This can enable stains occurring subsequent to treatment with SRA to be more easily cleaned in later washing procedures.

SRA's can include a variety of charged, e.g., anionic or even cationic (see U.S. Pat. No. 4,956,447), as well as noncharged monomer units and structures may be linear, branched or even star-shaped. They may include capping moieties which are especially effective in controlling molecular weight or altering the physical or surface-active properties. Structures and charge distributions may be tailored for application to different fiber or textile types and for varied detergent or detergent additive products.

In some embodiments, SRA's include oligomeric terephthalate esters, typically prepared by processes involving at least one transesterification/oligomerization, often with a metal catalyst such as a titanium(IV) alkoxide. Such esters may be made using additional monomers capable of being incorporated into the ester structure through one, two, three, four or more positions, without of course forming a densely crosslinked overall structure.

Suitable SRA's include: a sulfonated product of a substantially linear ester oligomer comprised of an oligomeric ester backbone of terephthaloyl and oxyalkyleneoxy repeat units and allyl-derived sulfonated terminal moieties covalently attached to the backbone, for example as described in U.S. Pat. No. 4,968,451; such ester oligomers can be prepared by (a) ethoxylating allyl alcohol, (b) reacting the product of (a) with dim ethyl terephthalate (“DMT”) and 1,2-propylene glycol (“PG”) in a two-stage transesterification/oligomerization procedure and (c) reacting the product of (b) with sodium metabisulfite in water; the nonionic end-capped 1,2-propylene/polyoxyethylene terephthalate polyesters of U.S. Pat. No. 4,711,730 for example those produced by transesterification/oligomerization of poly(ethyleneglycol) methyl ether, DMT, PG and poly(ethyleneglycol) (“PEG”); the partly- and fully-anionic-end-capped oligomeric esters of U.S. Pat. No. 4,721,580, such as oligomers from ethylene glycol (“EG”), PG, DMT and Na-3,6-dioxa-8-hydroxyoctanesulfonate; the nonionic-capped block polyester oligomeric compounds of U.S. Pat. No. 4,702,857, for example produced from DMT, Me-capped PEG and EG and/or PG, or a combination of DMT, EG and/or PG, Me-capped PEG and Na-dimethyl-5-sulfoisophthalate; and the anionic, especially sulfoaroyl, end-capped terephthalate esters of U.S. Pat. No. 4,877,896, the latter being typical of SRA's useful in both laundry and fabric conditioning products, an example being an ester composition made from m-sulfobenzoic acid monosodium salt, PG and DMT optionally but preferably further comprising added PEG, e.g., PEG 3400.

SRA's also include simple copolymeric blocks of ethylene terephthalate or propylene terephthalate with polyethylene oxide or polypropylene oxide terephthalate, see U.S. Pat. No. 3,959,230; cellulosic derivatives such as the hydroxyether cellulosic polymers available as METHOCEL from Dow; and the C₁-C₄ alkylcelluloses and C₄ hydroxyalkyl celluloses; see U.S. Pat. No. 4,000,093. Suitable SRA's characterized by poly(vinyl ester) hydrophobe segments include graft copolymers of poly(vinyl ester), e.g., C₁-C₆ vinyl esters, preferably poly(vinyl acetate), grafted onto polyalkylene oxide backbones. See European Patent Application 0 219 048. Commercially available examples include SOKALAN SRA's such as SOKALAN HP-22, available from BASF (Ludwigshafen, Germany). Other SRA's are polyesters with repeat units containing from about 10% to about 15% by weight of ethylene terephthalate together with from about 90% to about 80% by weight of polyoxyethylene terephthalate, derived from a polyoxyethylene glycol of average molecular weight 300-5,000. Commercial examples include ZELCON™ 5126 from Dupont (Wilmington, Del.) and MILEASE™ T from ICI (Bridgewater, N.J.)>

Another useful SRA is an oligomer having empirical formula (CAP)₂(EG/PG)₅(T)₅(SIP)₁ which comprises terephthaloyl (T), sulfoisophthaloyl (SIP), oxyethyleneoxy and oxy-1,2-propylene (EG/PG) units and which may be terminated with end-caps (CAP), preferably modified isethionates, as in an oligomer comprising one sulfoisophthaloyl unit, 5 terephthaloyl units, oxyethyleneoxy and oxy-1,2-propyleneoxy units in a defined ratio, typically from about 0.5:1 to about 10:1, and two end-cap units derived from sodium 2-(2-hydroxyethoxy)-ethanesulfonate. Said SRA may further comprise from about 0.5% to about 20%, by weight of the oligomer, of a crystallinity-reducing stabilizer, for example an anionic surfactant such as linear sodium dodecylbenzenesulfonate or a member selected from xylene-, cumene-, and toluene-sulfonates or mixtures thereof, these stabilizers or modifiers being introduced into the synthesis pot, all as taught in U.S. Pat. No. 5,415,807. Suitable monomers for the above SRA include Na 2-(2-hydroxyethoxy)-ethanesulfonate, DMT, Na-dimethyl 5-sulfoisophthalate, EG and PG.

Yet another group of useful SRA's are oligomeric esters comprising: (1) a backbone comprising (a) at least one unit selected from the group consisting of dihydroxysulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, preferably ethoxylated, isethionates, alkoxylated propanesulfonates, alkoxylated propanedisulfonates, alkoxylated phenolsulfonates, sulfoaroyl derivatives and mixtures thereof. Preferred of such esters are those of empirical formula:

{(CAP)x(EG/PG)y′(DEG)y″(PEG)y′″(T)z(SIP)z′(SEG)q(B)m}

wherein CAP, EG/PG, PEG, T and SIP are as defined hereinabove, (DEG) represents di(oxyethylene)oxy units; (SEG) represents units derived from the sulfoethyl ether of glycerin and related moiety units; (B) represents branching units which are at least trifunctional whereby ester linkages are formed resulting in a branched oligomer backbone; x is from about 1 to about 12; y′ is from about 0.5 to about 25; y″ is from 0 to about 12; y′″ is from 0 to about 10; y′+y″+y′″ totals from about 0.5 to about 25; z is from about 1.5 to about 25; z′ is from 0 to about 12; z+z′ totals from about 1.5 to about 25; q is from about 0.05 to about 12; m is from about 0.01 to about 10; and x, y′, y″, y′″, z, z′, q and m represent the average number of moles of the corresponding units per mole of said ester and said ester has a molecular weight ranging from about 500 to about 5,000.

In some embodiments, SEG and CAP monomers for the above esters include Na-2-(2-,3-dihydroxypropoxy)ethanesulfonate (“SEG”), Na-2-{2-(2-hydroxyethoxy)ethoxy}ethanesulfonate (“SE3”) and its homologs and mixtures thereof and the products of ethoxylating and sulfonating allyl alcohol. SRA esters of this class include the product of transesterifying and oligomerizing sodium 2-{2-(2-hydroxyethoxy)ethoxy}ethanesulfonate and/or sodium 2-[2-{2-(2-hydroxyethoxy)ethoxy}ethoxy]ethanesulfonate, DMT, sodium 2-(2,3-dihydroxypropoxy)ethane sulfonate, EG, and PG using an appropriate Ti(IV) catalyst and can be designated as (CAP)2(T)5(EG/PG)1.4(SEG)2.5(B)0.13 wherein CAP is (Na+ —O₃S[CH₂CH₂O]3.5)— and B is a unit from glycerin and the mole ratio EG/PG is about 1.7:1 as measured by conventional gas chromatography after complete hydrolysis.

Additional classes of SRA's include (I) nonionic terephthalates using diisocyanate coupling agents to link up polymeric ester structures, see U.S. Pat. Nos. 4,201,824 and 4,240,918; (II) SRA's with carboxylate terminal groups made by adding trimellitic anhydride to known SRA's to convert terminal hydroxyl groups to trimellitate esters. With a proper selection of catalyst, the trimellitic anhydride forms linkages to the terminals of the polymer through an ester of the isolated carboxylic acid of trimellitic anhydride rather than by opening of the anhydride linkage. Either nonionic or anionic SRA's may be used as starting materials as long as they have hydroxyl terminal groups which may be esterified. See U.S. Pat. No. 4,525,524; (III) anionic terephthalate-based SRA's of the urethane-linked variety, see U.S. Pat. No. 4,201,824; (IV) poly(vinyl caprolactam) and related co-polymers with monomers such as vinyl pyrrolidone and/or dimethylaminoethyl methacrylate, including both nonionic and cationic polymers, see U.S. Pat. No. 4,579,681; (V) graft copolymers, in addition to the SOKALAN™ types from BASF (Ludwigshafen, Germany) made, by grafting acrylic monomers on to sulfonated polyesters; these SRA's assertedly have soil release and anti-redeposition activity similar to known cellulose ethers: see EP 279,134 A, 1988; (VI) grafts of vinyl monomers such as acrylic acid and vinyl acetate on to proteins such as caseins, see EP 457,205; (VII) polyester-polyamide SRA's prepared by condensing adipic acid, caprolactam, and polyethylene glycol, especially for treating polyamide fabrics, see DE 2,335,044. Other useful SRA's are described in U.S. Pat. Nos. 4,240,918, 4,787,989, 4,525,524 and 4,877,896.

### Laundry Products

A non-limiting list of optional components of the present invention includes laundry detergents, fabric conditioners, and other wash, rinse, and dryer added products. The laundry products may comprise from about 0.1% to about 20% of the fabric care agent, preferably from about 0.2% to about 10%. The laundry products may also comprise from about 0.01% to about 5% of the delivery enhancing agent, preferably from about 0.02% to about 2%. Conventional components of fabric conditioners include but are not limited to surfactants and the like. Conventional components of detergent compositions include but are not limited to surfactants, bleaches and bleach activators, enzymes and enzyme stabilizing agents, suds boosters or suds suppressers, anti-tarnish and anticorrosion agents, non-builder alkalinity sources, chelating agents, organic and inorganic fillers, solvents, hydrotropes, optical brighteners, dyes, perfumes, and modified cellulose ether fabric treatment agents. The fabric care agents or delivery enhancing agent of the present invention may be a component of or added to a detergent composition or a fabric conditioner. The detergent composition may be in the form of a granule, liquid, or tablet. Detergent compositions of the present invention may be made in accordance with U.S. Pat. Nos. 6,274,540 and 6,306,817 and WIPO Publication Nos. WO 01/16237 published Mar. 8, 2001 and WO 01/16263 published on Mar. 8, 2001.

### Method of Use

The present invention further relates to a method for laundering fabric, said method comprising the step of contact fabric in need of cleaning with a liquid detergent composition according to the present invention. For the purposes of the present invention the term “contacting” is defined as “intimate contact of a fabric with an aqueous solution of a composition which comprises a liquid detergent composition of the present invention, wherein said composition is present in an amount of at least 10 ppm, or at least 100 ppm”. Contacting typically occurs by soaking, washing, rinsing, spraying the composition onto fabric, but can also include contact of a substrate inter alia a material onto which the composition has been absorbed, with the fabric. In some embodiments, laundering is the process. Temperatures for laundering can take place at a variety of temperatures, however, laundering typically occurs at a temperature less than about 30° C., preferably from about 5° C. to about 250° C.

### Liquid Laundry Detergent Compositions

Preferably, the laundry product compositions herein are formulated as liquid laundry detergent compositions. The liquid laundry detergent compositions preferably comprise from about 3% to about 98%, preferably from about 15% to about 95%, by weight of the liquid laundry detergent composition, of an aqueous liquid carrier which is preferably water. Preferably, the liquid laundry detergent compositions according to the present invention should provide a wash solution pH from about 6 to about 10, more preferably from about 7 to about 9, in order to maintain a preferred stain removal performance by the liquid laundry detergent compositions according to the present invention. If needed, the cleaning compositions may contain alkalinizing agents, pH control agents and/or buffering agents.

The density of the laundry detergent compositions herein preferably ranges from about 400 to about 1200 g/litre, more preferably from about 500 to about 1100 g/litre of composition measured at 20° C.

### EXAMPLES

The following example laundry product formulations may be made by traditional methods and means as known to one of ordinary skill in the art. Cationic deposition aids and the fabric care agents of the present invention may be mixed together prior to formulating in, adding to, or using in conjunction with, a laundry product. In addition, or in the alternative, the two components may be formulated into laundry products in separate steps. The performance boosting agents may be added to the liquid laundry detergent composition before or after the addition of the fabric care agent or the mixture of cationic deposition aid and the fabric care agent. In some embodiments, fabric care agent and cationic deposition aid are added after the addition of the performance boosters.

For the purposes of illustration only, and not be construed as limiting, the following examples of the liquid laundry detergent compositions of the present invention are provided below. Examples 1-28 illustrate formulations for pourable liquid laundry detergent compositions and Examples 29-40 illustrate formulations for gelled laundry detergent compositions.

| | Example Number: | | | | | |
|---|---|---|---|---|---|---|
| Ingredients | 1 | 2 | 3 | 4 | 5 | 6 |
| (assuming 100% activity) | weight % | weight % | weight % | weight % | weight % | weight % |
| AES¹ | 21.0 | 12.6 | 21.0 | 12.6 | 21.0 | 5.7 |
| LAS² | — | 1.7 | — | 1.7 | — | 4.8 |
| Branched Alkyl sulfate¹ | — | 4.1 | — | 4.1 | — | 1.3 |
| Neodol 23-9³ | 0.4 | 0.5 | 0.4 | 0.5 | 0.4 | 0.2 |
| C12 trimethylammonium | 3.0 | — | 3.0 | — | 3.0 | — |
| chloride⁴ | | | | | | |
| Citric Acid | 2.5 | 2.4 | 2.5 | 2.4 | 2.5 | — |
| C₁₂₋₁₈ Fatty Acids | 3.4 | 1.3 | 3.4 | 1.3 | 3.4 | 0.3 |
| Protease B | 0.4 | 0.4 | 0.4 | 0.4 | 0.4 | 0.1 |
| Carezyme⁵ | 0.1 | 0.1 | 0.1 | 0.1 | 0.1 | — |
| Tinopal AMS-X⁶ | 0.1 | 0.1 | 0.1 | — | 0.1 | 0.3 |
| TinopalCBS-X⁶ | — | — | — | | 0.1 | — |
| ethoxylated (EO₁₅) | 0.3 | 0.4 | 0.3 | 0.4 | 0.3 | 0.4 |
| tetraethylene pentaimine⁷ | | | | | | |
| PEI 600 EO₂₀⁸ | 0.6 | 0.8 | 0.6 | 0.8 | 0.6 | 0.3 |
| Zwitterionic ethoxylated | 0.8 | — | 0.8 | — | 0.8 | — |
| quaternized sulfated | | | | | | |
| hexamethylene diamine⁹ | | | | | | |
| PP-5495¹⁰ | 3.4 | 3.0 | 3.4 | 3.0 | 3.4 | 2.7 |
| KF-889¹¹ | — | — | — | — | 3.4 | — |
| Acrylamide/MAPTAC¹² | 0.2 | 0.2 | 0.2 | 0.2 | — | 0.3 |
| Diethylene triamine penta | 0.2 | 0.3 | 0.2 | 0.2 | 0.2 | — |
| acetate, MW = 393 | | | | | | |
| Mica/TiO2¹³ | 0.2 | 0.1 | — | — | — | 0.1 |
| Ethyleneglycol distearate¹⁴ | — | — | 1.0 | 1.0 | | — |
| water, perfumes, dyes, and | to | to | to | to | to | to |
| other optional | 100% | 100% | 100% | 100% | 100% | 100% |
| agents/components | balance | balance | balance | balance | balance | balance |

| | Example Number: | | | | |
|---|---|---|---|---|---|
| Ingredient (assuming 100% | 7 | 8 | 9 | 9 | 10 |
| activity) | weight % | weight % | weight % | weight % | weight % |
| AES¹ | 21.0 | 12.6 | 21.0 | 21.0 | 15.0 |
| LAS² | — | 1.7 | — | — | — |
| Branched Alkyl sulfate¹ | — | 4.1 | — | — | — |
| Methyl ester sulfonate¹⁹ | — | — | — | — | 5.0 |
| Neodol 23-9³ | 0.4 | 0.5 | 0.4 | 0.4 | 0.4 |
| C12 trimethylammonium chloride⁴ | 3.0 | — | 3.0 | 3.0 | 3.0 |
| Citric Acid | 2.5 | 2.4 | 2.5 | 2.5 | 2.5 |
| C₁₂₋₁₈ Fatty Acids | 3.4 | 1.3 | 3.4 | 3.4 | 3.4 |
| Protease B | 0.4 | 0.4 | 0.4 | 0.4 | 0.4 |
| Carezyme⁵ | 0.1 | 0.1 | 0.1 | 0.1 | 0.1 |
| Tinopal AMS-X⁸ | 0.1 | 0.1 | 0.1 | 0.1 | 0.1 |
| TinopalCBS-X⁸ | — | — | — | — | — |
| ethoxylated (EO₁₅) | 0.3 | 0.4 | 0.3 | 0.3 | 0.3 |
| tetraethylene pentaimine⁴ | | | | | |
| PEI 600 EO₂₀⁸ | 0.6 | 0.8 | 0.6 | 0.6 | 0.6 |
| Zwitterionic ethoxylated | 0.8 | — | 0.8 | 0.8 | 0.8 |
| quaternized sulfated | | | | | |
| hexamethylene diamine⁹ | | | | | |
| PP-5495¹⁰ | 3.4 | 3.0 | 3.4 | 3.4 | 3.4 |
| Mirapol 550¹⁵ | 0.2 | 0.2 | 0.2 | 0.2 | 0.2 |
| Diethylene triamine penta | 0.2 | 0.3 | 0.2 | 0.2 | 0.2 |
| acetate, MW = 393 | | | | | |
| Mica/TiO2¹³ | 0.2 | — | 0.1 | 0.1 | 0.1 |
| Ethyleneglycol distearate¹⁴ | | 1.0 | — | — | — |
| Trihydroxylstearin | 0.1 | 0.1 | — | — | |
| water, perfumes, dyes, and | to | to | to | to | to |
| other optional | 100% | 100% | 100% | 100% | 100% |
| agents/components | balance | balance | balance | balance | balance |

| | Example Number: | | | | | |
|---|---|---|---|---|---|---|
| Ingredient (assuming 100% | 11 | 12 | 13 | 14 | 15 | 16 |
| activity) | weight % | weight % | weight % | weight % | weight % | weight % |
| AES¹ | 10.6 | 10.6 | 10.6 | 10.6 | 10.6 | 10.6 |
| LAS² | 0.8 | 0.8 | 0.8 | 0.8 | 0.8 | 0.8 |
| Neodol 45-8¹⁸ | 6.3 | 6.3 | 6.3 | 6.3 | 6.3 | 6.3 |
| Citric Acid | 3.8 | 3.8 | 3.8 | 3.8 | 3.8 | 3.8 |
| C₁₂₋₁₈ Fatty Acids | 7.0 | 7.0 | 7.0 | 7.0 | 7.0 | 7.0 |
| Protease B | 0.35 | 0.35 | 0.35 | 0.35 | 0.35 | 0.35 |
| Tinopal AMS-X⁶ | 0.09 | 0.09 | 0.09 | 0.09 | 0.09 | 0.09 |
| Zwitterionic ethoxylated | 1.11 | 1.11 | 1.11 | 1.11 | 1.11 | 1.11 |
| quaternized sulfated | | | | | | |
| hexamethylene diamine⁹ | | | | | | |
| Dequest 2010¹⁶ | 0.17 | 0.17 | 0.17 | 0.17 | 0.17 | 0.17 |
| PP-5495¹⁰ | 4.0 | — | 4.0 | 4.0 | — | 4.0 |
| KF-889¹¹ | — | 4.0 | | | 4.0 | |
| Cationic HEC¹⁷ | 0.28 | 0.28 | — | — | — | |
| Poly(acrylamide/ | — | — | 0.47 | — | 0.47 | — |
| MAPTAC)¹² | | | | | | |
| Mirapol 550¹⁵ | — | — | — | 0.47 | | |
| Hydrogenated castor oil | 0.2 | 0.2 | 0.2 | 0.2 | 0.2 | 0.2 |
| Mica/TiO2¹³ | 0.2 | 0.2 | 0.2 | 0.2 | 0.2 | 0.2 |
| Ethyleneglycol distearate¹⁴ | 0.2 | 0.2 | 0.2 | 0.2 | 0.2 | 0.2 |
| water, perfumes, dyes, and | to | to | to | to | to | to |
| other optional | 100% | 100% | 100% | 100% | 100% | 100% |
| agents/components | balance | balance | balance | balance | balance | balance |
| | Example Number: | | | | | |
| Ingredients | 17 | 18 | 19 | 20 | 21 | 22 |
| (assuming 100% activity) | weight % | weight % | weight % | weight % | weight % | weight % |
| AES¹ | 2.4 | 2.4 | 12.8 | — | 6.0 | — |
| LAS² | 12.8 | 12.8 | 12.8 | 5.0 | 0.8 | 6.7 |
| Branched Alkyl sulfate¹ | — | — | — | — | — | — |
| Neodol 23-9³ | 2.4 | 6.0 | 2.4 | 6.5 | 3.5 | 9.1 |
| C12 trimethylammonium | — | — | — | — | — | 1.5 |
| chloride⁴ | | | | | | |
| Citric Acid | 2.5 | 2.5 | 2.5 | 2.4 | 2.5 | 2.5 |
| C₁₂₋₁₈ Fatty Acids | 15.0 | 5.0 | 7.0 | 5.0 | 5.8 | 5.8 |
| Protease B | 0.4 | 0.4 | 0.4 | 0.4 | 0.4 | 0.1 |
| Carezyme⁵ | 0.1 | 0.1 | 0.1 | 0.1 | 0.1 | — |
| Tinopal AMS-X⁶ | 0.1 | 0.1 | 0.1 | — | 0.1 | 0.3 |
| TinopalCBS-X⁶ | — | — | — | | 0.1 | — |
| ethoxylated (EO₁₅) | 0.3 | 0.4 | 0.3 | 0.4 | 0.3 | 0.4 |
| tetraethylene pentaimine⁷ | | | | | | |
| PEI 600 EO₂₀⁸ | 0.6 | 0.8 | 0.6 | 0.8 | 0.6 | 0.3 |
| Zwitterionic ethoxylated | 0.8 | — | 0.8 | — | 0.8 | — |
| quaternized sulfated | | | | | | |
| hexamethylene diamine⁹ | | | | | | |
| PP-5495¹⁰ | 1.5 | 2.0 | — | 1.0 | 1.0 | 2.7 |
| KF-889¹¹ | — | — | 3.0 | — | 3.4 | — |
| Acrylamide/MAPTAC¹² | 0.2 | 0.2 | 0.2 | 0.2 | — | 0.3 |
| Diethylene triamine penta | 0.2 | 0.3 | 0.2 | 0.2 | 0.2 | — |
| acetate, MW = 393 | | | | | | |
| Mica/TiO2¹³ | 0.2 | 0.1 | — | — | — | 0.1 |
| Ethyleneglycol distearate¹⁴ | — | — | 1.0 | 1.0 | | — |
| water, perfumes, dyes, and | to | to | to | to | to | to |
| other optional | 100% | 100% | 100% | 100% | 100% | 100% |
| agents/components | balance | balance | balance | balance | balance | balance |
| | Example Number: | | | | | |
| Ingredient (assuming 100% | 23 | 24 | 25 | 26 | 27 | 28 |
| activity) | weight % | weight % | weight % | weight % | weight % | weight % |
| AES¹ | 2.4 | 2.4 | 12.8 | — | 6.0 | — |
| LAS² | 12.8 | 12.8 | 12.8 | 5.0 | 0.8 | 6.7 |
| Neodol 23-9³ | 2.4 | 6.0 | 2.4 | 6.5 | 3.5 | 9.1 |
| C12 trimethylammonium | — | — | — | — | — | 1.5 |
| chloride⁴ | | | | | | |
| Citric Acid | 2.5 | 2.5 | 2.5 | 2.4 | 2.5 | 2.5 |
| C₁₂₋₁₈ Fatty Acids | 15.0 | 5.0 | 7.0 | 5.0 | 5.8 | 5.8 |
| Protease B | 0.35 | 0.35 | 0.35 | 0.35 | 0.35 | 0.35 |
| Tinopal AMS-X⁶ | 0.09 | 0.09 | 0.09 | 0.09 | 0.09 | 0.09 |
| Zwitterionic ethoxylated | 1.11 | 1.11 | 1.11 | 1.11 | 1.11 | 1.11 |
| quaternized sulfated | | | | | | |
| hexamethylene diamine⁹ | | | | | | |
| Dequest 2010¹⁶ | 0.17 | 0.17 | 0.17 | 0.17 | 0.17 | 0.17 |
| PP-5495¹⁰ | 2.0 | — | 1.5 | 1.0 | — | 0.5 |
| KF-889¹¹ | — | 2.0 | | | 1.0 | |
| Cationic HEC¹⁷ | 0.28 | 0.28 | — | — | — | |
| Poly(acrylamide/ | — | — | 0.47 | — | 0.47 | — |
| MAPTAC)¹² | | | | | | |
| Mirapol 550¹⁵ | — | — | — | 0.47 | | |
| Hydrogenated castor oil | 0.2 | 0.2 | 0.2 | 0.2 | 0.2 | 0.2 |
| Mica/TiO2¹³ | 0.2 | 0.2 | 0.2 | 0.2 | 0.2 | 0.2 |
| Ethyleneglycol distearate¹⁴ | 0.2 | 0.2 | 0.2 | 0.2 | 0.2 | 0.2 |
| water, perfumes, dyes, and | to | to | to | to | to | to |
| other optional | 100% | 100% | 100% | 100% | 100% | 100% |
| agents/components | balance | balance | balance | balance | balance | balance |

¹C₁₀-C₁₈ alkyl ethoxy sulfate supplied by Shell Chemicals, Houston TX
²C₉-C₁₅ linear alkyl benzene sulfonate supplied by Huntsman Corp, Salt lake City UT
³supplied by Shell Chemicals, Houston TX
⁴Supplied by Akzo Chemicals, Chicago, IL
⁵Supplied by Novozymes, Copanhagen, Denmark
⁶Supplied by Ciba Specialty Chemicals, High Point, NC
⁷as described in U.S. Pat. No. 4,597,898
⁸as described in U.S. Pat. No. 5,565,145
⁹available under the tradename LUTENSIT ® from BASF (Ludwigshafen, Germany) and such as those described in WO 01/05874
¹⁰supplied by Dow Corning Corporation, Midland, MI
¹¹supplied by Shin-Etsu Silicones, Akron, OH
¹²supplied by Nalco Chemicals of Naperville, IL
¹³supplied by Ekhard America, Louisville, KY
¹⁴Supplied by Degussa Corporation, Hopewell, VA
¹⁵Supplied by Rhodia Chemie, Aubervilliers, France
¹⁶Supplied by Aldrich Chemicals, Greenbay, WI
¹⁷Supplied by Dow Chemicals, Edgewater, NJ
¹⁸Supplied by Shell Chemicals, Houston TX
¹⁹Supplied by Stepan Chemicals, Northfield, IL

| | Example Number: | | | | | | | |
|---|---|---|---|---|---|---|---|---|
| Ingredients (assuming | 29 | 30 | 31 | 32 | 33 | 34 | 35 | 36 |
| 100% activity) | weight % | weight % | weight % | weight % | weight % | weight % | weight % | weight % |
| C12-15 Alkyl | — | 20 | — | 20 | — | 20 | — | 20 |
| polyethoxylate (1.8) | | | | | | | | |
| sulphate, Na salt | | | | | | | | |
| C12-15Alkyl | 12 | — | 12 | — | 12 | — | 12 | — |
| polyethoxylate (3.0) | | | | | | | | |
| sulphate, Na salt | | | | | | | | |
| C12-14 | 1.9 | 0.3 | 1.9 | 0.3 | 1.9 | 0.3 | 1.9 | 0.3 |
| alkylpolyethoxylate | | | | | | | | |
| (7) | | | | | | | | |
| C12 linear | 2.9 | — | 2.9 | — | 2.9 | — | 2.9 | — |
| alkylbenzene sulfonic | | | | | | | | |
| acid | | | | | | | | |
| C12 alkyl, N,N.N | — | 2.2 | — | 2.2 | — | 2.2 | — | 2.2 |
| trimethyl ammonium | | | | | | | | |
| chloride | | | | | | | | |
| C12-18 fatty acids | 7.4 | 5.0 | 7.4 | 5.0 | 7.4 | 5.0 | 7.4 | 5.0 |
| Citric acid | 1.0 | 3.4 | 1.0 | 3.4 | 1.0 | 3.4 | 1.0 | 3.4 |
| Hydroxyethylidene | 0.25 | — | 0.25 | — | 0.25 | — | 0.25 | — |
| 1,1 diphosphonic acid | | | | | | | | |
| Diethylenetriamine | — | 0.50 | — | 0.50 | — | 0.50 | — | 0.50 |
| pentaacetic acid | | | | | | | | |
| Trans-Sulfated | 1.9 | — | 1.9 | — | 1.9 | — | 1.9 | — |
| Ethoxylated | | | | | | | | |
| Hexamethylene | | | | | | | | |
| Diamine Quat | | | | | | | | |
| Acrylamide/MAPTAC | 0.4 | 0.4 | — | — | 0.4 | 0.4 | — | — |
| Lupasol SK (1) | — | — | 3.0 | 3.0 | — | — | 3.0 | 3.0 |
| Carezyme | 0.1 | — | 0.1 | — | 0.1 | — | 0.1 | — |
| 1,2 propandiol | 1.7 | 3.8 | 1.7 | 3.8 | 1.7 | 3.8 | 1.7 | 3.8 |
| Ethanol | 1.5 | 2.8 | 1.5 | 2.8 | 1.5 | 2.8 | 1.5 | 2.8 |
| Diethyleneglycol | — | 1.5 | — | 1.5 | — | 1.5 | — | 1.5 |
| Boric acid | 1.0 | 1.0 | 1.0 | 1.0 | 1.0 | 1.0 | 1.0 | 1.0 |
| Na Cumene sulfonate | — | 1.7 | — | 1.7 | — | 1.7 | — | 1.7 |
| Monoethanolamine | 3.3 | 2.5 | 3.3 | 2.5 | 3.3 | 2.5 | 3.3 | 2.5 |
| Perfume | 0.9 | 0.6 | 0.9 | 0.6 | 0.9 | 0.6 | 0.9 | 0.6 |
| Hydrogenated castor | 0.1 | — | 0.1 | — | 0.1 | — | 0.1 | — |
| oil | | | | | | | | |
| Pearlescent agent | 0.1 | 0.05 | 0.1 | 0.05 | 0.1 | 0.05 | 0.1 | 0.05 |
| (mica) | | | | | | | | |
| PP 5495 (2) | 6.0 | 6.0 | 6.0 | 6.0 | — | — | — | — |
| DC 1664 (3) | — | — | — | — | 6.0 | 6.0 | 6.0 | 6.0 |
| NaOH | To pH | To pH | To pH | To pH | To pH | To pH | To pH | To pH |
| | 8.0 | 8.0 | 8.0 | 8.0 | 8.0 | 8.0 | 8.0 | 8.0 |
| water | balance | balance | balance | balance | balance | balance | balance | balance |

Example Number:

| Ingredients | 37 | 38 | 39 | 40 |
|---|---|---|---|---|
| (assuming 100% activity) | weight % | weight % | weight % | weight % |
| C12-15 Alkyl polyethoxylate | 20 | 20 | 20 | 20 |
| (1.8) sulphate, Na salt | | | | |
| C12-15Alkyl polyethoxylate | — | — | — | — |
| (3.0) sulphate, Na salt | | | | |
| C12-14 alkylpolyethoxylate (7) | 0.3 | 0.3 | 0.3 | 0.3 |
| C12 linear alkylbenzene | — | — | — | — |
| sulfonic acid | | | | |
| C12 alkyl, N,N.N trimethyl | 2.2 | 2.2 | 2.2 | 2.2 |
| ammonium chloride | | | | |
| C12-18 fatty acids | 5.0 | 5.0 | 5.0 | 5.0 |
| Citric acid | 3.4 | 3.4 | 3.4 | 3.4 |
| Hydroxyethylidene 1,1 | — | — | — | — |
| diphosphonic acid | | | | |
| Diethylenetriamine pentaacetic | 0.50 | 0.50 | 0.50 | 0.50 |
| acid | | | | |
| Trans-Sulfated Ethoxylated | — | — | — | — |
| Hexamethylene Diamine Quat | | | | |
| Acrylamide/MAPTAC | 0.4 | 0.4 | 0.4 | — |
| Lupasol SK (1) | — | — | — | 3.0 |
| Carezyme | — | — | — | — |
| 1,2 propandiol | 3.8 | 3.8 | 3.8 | 3.8 |
| Ethanol | 2.8 | 2.8 | 2.8 | 2.8 |
| Diethyleneglycol | 1.5 | 1.5 | 1.5 | 1.5 |
| Boric acid | 1.0 | 1.0 | 1.0 | 1.0 |
| Na Cumene sulfonate | 1.7 | 1.7 | 1.7 | 1.7 |
| Monoethanolamine | 2.5 | 2.5 | 2.5 | 2.5 |
| Perfume | 0.6 | 0.6 | 0.6 | 0.6 |
| Hydrogenated castor oil | 0.2 | 0.2 | 0.2 | 0.1 |
| Pearlescent agent (mica) | 0.05 | 0.05 | 0.05 | 0.05 |
| PP 5495 (2) | — | 6.0 | — | — |
| DC 1664 (3) | — | — | 6.0 | 6.0 |
| Trihydroxylstearin (4) | 0.1 | — | — | — |
| NaOH | To pH | To pH | To pH | To pH |
| | 8.0 | 8.0 | 8.0 | 8.0 |
| water | balance | balance | balance | balance |

(1) Polyethyleneimine polymer amidated with acetic acid available from BASF.
(2) Silicone polyether commercially available from Dow Corning.
(3) Polydimethylsiloxane emulsion available from Dow Corning
(4) Sold as Thixcin ™

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising by weight percentage of said composition:
a. from about 1% to about 80% of anionic surfactant;
b. from about 0.1% to about 10% of fabric care agent;
c. from about 0.01% to about 2% of deposition aid; and
d. from about 0.05% to about 10% of performance booster selected from enzymes, anionic polymers, and brighteners.

2. The liquid laundry detergent composition of claim 1, wherein said anionic surfactant is selected from the group of: C₈-C₂₂ fatty acid or its salts; C₁₁-C₁₈ alkyl benzene sulfonates; C₁₀-C₂₀ branched-chain and random alkyl sulfates; C₁₀-C₁₈ alkyl alkoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units; modified alkylbenzene sulfonate; C₁₂-C₂₀ methyl ester sulfonate; C₁₀-C₁₈ alpha-olefin sulfonate; C₆-C₂₀ sulfosuccinates; and combinations thereof.

3. The liquid laundry detergent composition of claim 1, wherein said fabric care agent provides fabric care benefits selected from the group of: fabric softening; color protection; color restoration; pill/fuzz reduction; anti-abrasion; anti-wrinkling; and combinations thereof.

4. The liquid laundry detergent composition of claim 1, wherein said fabric care agent is selected from the group of: silicone derivates; oily sugar derivatives; dispersible polyolefins; polymer latexes; cationic surfactants; and combinations thereof.

5. The liquid laundry detergent composition of claim 1, wherein said enzyme is selected from the group of: proteases; amylases; lipases; cellulases; carbohydrase; xyloglucanase; mannanase; pectate lyase; and combinations thereof.

6. The liquid laundry detergent composition of claim 1, wherein said performance booster is a brightener.

7. The liquid laundry detergent composition of claim 6, wherein said brightener is selected from the group of: disodium 4,4′-bis-(2-sulfostyryl) biphenyl; benzenesulfonic acid; 2,2′-(1,2-ethenediyl)bis[5-[4-[(2-hydroxyethyl)methylamino]-6-(phenylamino)-1,3,5-triazin-2-y]amino]-, disodium salt; disodium 4,4′-bis{[4-anilino-6-[bis(2-hydroxyethyl)amino-s-triazin-2-yl]-amino}-2,2′-stilbenedisulfonate; disodium 4,4′-bis[(4-anilino-6-(N-2-hydroxyethyl-N-methylamino)-s-triazine-2-yl)amino]2,2′-stilbenedisulfonate; disodium 4,4′-bis{[4-anilino-6-methylamino-s-triazin-2-yl]-amino}-2,2′-stilbenedisulfonate; disodium 4,4″-bis[4,6-di-anilino-s-triazin-2-yl]-2,2′-stilbenedisulfonate; disodium 4,4′-bis{[4-anilino-6-morpholino-s-triazin-2-yl}-amino)-2,2′-stilbenedisulfonate; and combinations thereof.

8. The liquid laundry detergent composition of claim 1, wherein said performance booster is an anionic dispersant polymer.

9. The liquid laundry detergent composition of claim 1, further comprising a pearlescent agent.

10. The liquid laundry detergent composition of claim 9, wherein said pearlescent agent is selected from the group of: mica; bismuth oxychloride; fish scales; mono and diesters of alkylene glycol of the formula: 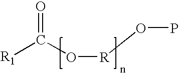
wherein:
a. R₁ is linear or branched C12-C22 alkyl group;
b. R is linear or branched C2-C4 alkylene group;
c. P is selected from the group of: H; C1-C4 alkyl; or —COR₂; and
d. n=1-3.

11. The liquid laundry detergent composition of claim 10, wherein said pearlescent agent is selected from the group of: mica; ethylyene glycol distearate; ethylene glycolmonostearate; bismuth oxychloride; and combinations thereof.

12. The liquid laundry detergent composition of claim 10, further comprising laundry adjuncts selected from the group of: nonionic surfactant; builder; polymeric soil release agent; and combinations thereof

13. A liquid laundry detergent composition comprising by weight percentage of said composition:
a. from about 1% to about 80% of anionic surfactant selected from the group of: C₈-C₂₂ fatty acid or its salts; C₁₁-C₁₈ alkyl benzene sulfonates; C₁₀-C₂₀ branched-chain and random alkyl sulfates; C₁₀-C₁₈ alkyl alkoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units; modified alkylbenzene sulfonate; C₁₂-C₂₀ methyl ester sulfonate; C₁₀-C₁₈ alpha-olefin sulfonate; C₆-C₂₀ sulfosuccinates; and combinations thereof;
b. from about 0.1% to about 10% of fabric care agent;
c. from about 0.05% to about 10% performance booster comprising brightener; and
d. from about 0.01% to about 5% of pearlescent agent selected from the group of: mica; bismuth oxychloride; fish scales; and mono and diesters of alkylene glycol of the formula: 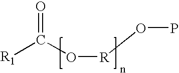
wherein:
a. R₁ is linear or branched C12-C22 alkyl group;
b. R is linear or branched C2-C4 alkylene group;
c. P is selected from the group of: H; C1-C4 alkyl; or —COR₂; and
d. n=1-3.

14. The liquid laundry detergent composition of claim 13, wherein said fabric care agent is selected from the group of: silicone derivates; oily sugar derivatives; dispersible polyolefins; polymer latexes; cationic surfactants; and combinations thereof.

15. The liquid laundry detergent composition of claim 13, wherein said brightener is selected from the group of: disodium 4,4′-bis-(2-sulfostyryl) biphenyl; benzenesulfonic acid; 2,2′-(1,2-ethenediyl)bis[5-[4-[(2-hydroxyethyl)methylamino]-6-(phenylamino)-1,3,5-triazin-2-y]amino]-, disodium salt; disodium 4,4′-bis{[4-anilino-6-[bis(2-hydroxyethyl)amino-s-triazin-2-yl]-amino})-2,2′-stilbenedisulfonate; disodium 4,4′-bis[(4-anilino-6-(N-2-hydroxyethyl-N-methylamino)-s-triazine-2-yl)amino]2,2′-stilbenedisulfonate; disodium 4,4′-bis{[4-anilino-6-methylamino-s-triazin-2-yl]-amino}-2,2′-stilbenedisulfonate; disodium 4,4″-bis[4,6-di-anilino-s-triazin-2-yl]-2,2′-stilbenedisulfonate; disodium 4,4′-bis{[4-anilino-6-morpholino-s-triazin-2-yl}-amino}-2,2′-stilbenedisulfonate; and combinations thereof.

16. The liquid laundry detergent composition of claim 13, further comprising enzyme.

17. The liquid laundry detergent composition of claim 13, further comprising laundry adjuncts selected from the group of: nonionic surfactant; builder; polymeric soil release agent; and combinations thereof.

18. A method of laundering fabric, said method comprising the step of contacting fabric with a liquid laundry detergent composition comprising by weight percentage of said composition:
a. from about 1% to about 80% of anionic surfactant;
b. from about 0.1% to about 10% of fabric care agent;
c. from about 0.01% to about 2% of deposition aid; and
d. from about 0.05% to about 10% of performance booster selected from enzymes, anionic polymers, and brighteners.

19. The method of claim 18, wherein said anionic surfactant is selected from the group of: C₈-C₂₂ fatty acid or its salts; C₁₁-C₁₈ alkyl benzene sulfonates; C₁₀-C₂₀ branched-chain and random alkyl sulfates; C₁₀-C₁₈ alkyl alkoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units; modified alkylbenzene sulfonate; C₁₂-C₂₀ methyl ester sulfonate; C₁₀-C₁₈ alpha-olefin sulfonate; C₆-C₂₀ sulfosuccinates; and combinations thereof.

20. The method of claim 18, wherein said liquid laundry detergent composition further comprises a pearlescent agent selected from the group of: mica; bismuth oxychloride; fish scales; mono and diesters of alkylene glycol of the formula: 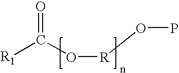
wherein:
a. R₁ is linear or branched C12-C22 alkyl group;
b. R is linear or branched C2-C4 alkylene group;
c. P is selected from the group of: H; C1-C4 alkyl; or —COR₂;
d. R₂ is C4-C22 alkyl, preferably C12-C22 alkyl;
and n=1-3.
